(19) United States
(12) Patent Application Publication
(10) Pub. No.: US 2004/0240857 A1
(43) Pub. Date: Dec. 2, 2004

(54) Digital video device for integration in the network

(76) Inventor: Marco Winter, Hannover (DE)

Correspondence Address: Joseph S Tripoli, Patent Operations, Thomson Licensing Inc, P O Box 5312, Princeton, NJ, 08543-5312, US

(21) Appl. No.: 10/484,860

(22) PCT Filed: Jul. 17, 2002
(86) PCT No.: PCT/EP02/07918

(30) Foreign Application Priority Data
Jul. 25, 2001 (DE) 101 36 176.9

(51) Int. Cl. H04N 5/76

(52) U.S. Cl. 386/98; 386/111; 386/124

(57) ABSTRACT

The present invention relates to a device and a method for the reproduction and/or recording of digital video signals in a device-specific data format based on a transport stream. One object of the invention is to propose a digital video device which utilizes a coder, present for generating the transport stream, in order to convert analogue video signals entering into the device into digital video signals in a data format used in a network, and to feed the digital video signals into such a network. According to the invention, the object is achieved by virtue of the fact that a digital video device has an additional converter, which converts the transport stream into a digital video signal in a data format used by the network.

The present invention relates to a device and a method for the reproduction and/or recording of digital video signals in a device-specific data format based on a transport stream generated by a coder.

Such devices are known for example as digital video recorders, DVD players and/or recorders, hard disk video recorders and digital camcorders from consumer electronics. The term digital video devices is used hereinafter for these devices.

For the reproduction and/or recording of digital video signals on storage media, digital video devices generally use data formats based on an MPEG II transport stream, or the MPEG II transport stream directly. For recording on storage media, analogue video signals entering into the device must firstly be converted into the MPEG II transport stream and subsequently be converted, if appropriate, into digital video signals in a device-specific data format. Accordingly, for reproduction on analogue output devices, the digital video signals in the device-specific data format which are recorded on a storage medium must firstly be converted into the MPEG II transport stream and subsequently be converted into analogue video signals. If the video signals on the storage medium are already present as MPEG II transport stream, then the conversion is obviated. For recording and reproduction, digital video devices have an MPEG II coder and decoder for the conversion of analogue video signals into an MPEG II transport stream, and vice versa, and also, if appropriate, device-specific converters for conversion between MPEG II transport stream and device-specific data format. The MPEG II coder and decoder is one of the most cost-intensive electronic components of a digital video device.

For the transmission of digital data in networks, the DVB data format exists as an international standard. DVB stands for Digital Video Broadcasting. In addition to the transmission of digital video signals, the transmission of digital radio programmes and computer files and of other digital data is also possible by means of the DVB data format. DVB data signals are based on an MPEG II transport stream.

In the future, devices from the field of consumer electronics will be networked with one another and with PCs to a greater and greater extent. If analogue video signals are intended to be fed into such a network, this requires a special conversion device which converts the analogue video signals into digital video signals in a data format suitable for the network. This may be, for example, a plug-in card for a PC.

One object of the invention is to propose a digital video device which utilizes the existing coder in order to convert analogue video signals entering into the device into digital video signals in a data format which is used in a network, and to feed the digital video signals into such a network, so that a separate conversion device is not required.

According to the invention, the object is achieved by virtue of the fact that a digital video device having a coder which converts an analogue video signal fed into the device into a transport stream has an additional converter which converts the transport stream into a digital video signal in a data format which is based on the same transport stream and is used by a network, the converted video signal being fed into such a network via an output of the device. The use of an additional converter whilst at the same time utilizing the existing coder is a cost-effective solution for converting analogue video signals into digital video signals which can be fed into a network.

The digital video device advantageously has a second converter and a decoder, the second converter converting a digital video signal in the data format used by the network, which is received from such a network, into the transport stream, and the decoder converting the transport stream into an analogue video signal which is output via an analogue output of the device. This has the advantage that the digital video device can also convert digital video signals-generated by other devices in the network into analogue video signals which can be displayed on analogue display devices.

In a further advantageous embodiment, the digital video device has two further converters, the first converter converting the transport stream into a digital video signal in a device-specific data format and the second converter converting a digital video signal in the device-specific data format into the transport stream. It goes without saying that the converters can also be combined in a single module. In this way, it is possible to store digital video signals, which are received from a network, in the device-specific data format on a storage medium and to condition digital video signals, which are reproduced in the device-specific data format from a storage medium, for a network and to feed them into the latter.

A method according to the invention for converting an analogue video signal into a digital video signal in a data format which is used by a network and is based on a transport stream which simultaneously forms the basis for a device-specific first data format consists in converting the analogue video signal into the transport stream using a coder and in converting the transport stream into the digital video signal in the second data format using a converter.

A method according to the invention for converting a digital video signal in a data format which is used by a network and is based on a transport stream which simultaneously forms the basis for a device-specific first data format, into an analogue video signal, consists in converting the digital video signal in the second data format into the transport stream using a converter and in converting the transport stream into the analogue video signal using a decoder.

According to the invention, the digital video device and the method use an MPEG II transport stream as the transport stream. This is advantageous since MPEG II is an internationally agreed standard which forms the basis for various device-specific data formats.

The digital video device and the method advantageously use a DVB data format for the digital video signal which is fed into the network. Since DVB is an international standard for data exchange in networks and the transmission of digital video signals, compatibility with the majority of networks is ensured in this way.

According to the invention, the device-specific data format used by the digital video device and by the method for the digital video signal is a data format in accordance with the DVD specifications.

It goes without saying that combinations of advantageous features likewise lie within the scope of validity of the invention.

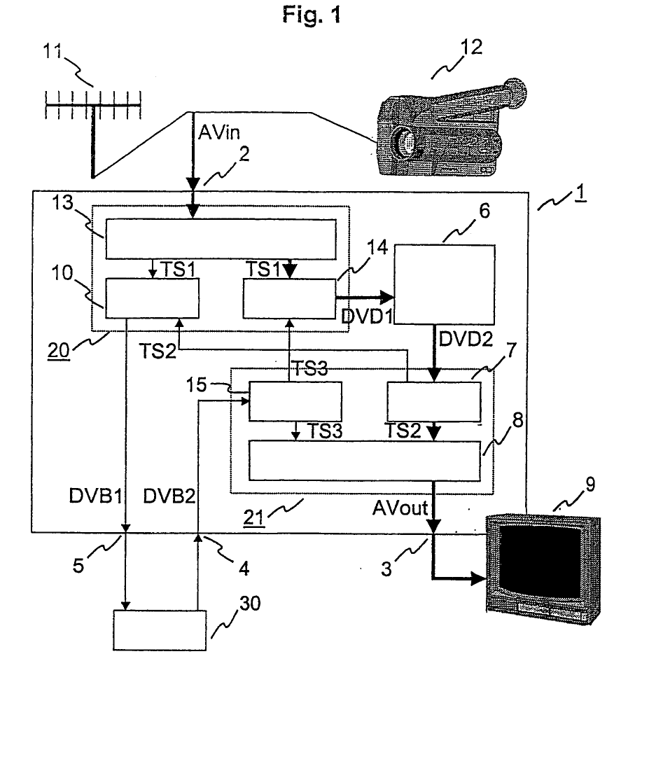

To provide a better understanding, the invention will be explained below using the advantageous exemplary embodiment shown in FIG. 1, in which:

FIG. 1 shows a digital video device according to the invention using the example of a DVD recorder.

A digital video device (1) according to the invention is illustrated in FIG. 1 using the example of a DVD recorder. In this case, the arrows depicted bold mark those steps of the processing of the video signals which are realized in a DVD recorder according to the prior art. Thin arrows mark those processing steps of the video signals which a DVD recorder according to the invention additionally has to carry out. Firstly, a description will be given of the steps of the processing of a video signal in a DVD recorder as are known from the prior art.

The DVD recorder (1) contains a signal processing unit (20), which converts an analogue video signal (AVin), which originates for example from a receiving antenna (11) or a camcorder (12) and is fed into the DVD recorder (1) via an analogue input (2), into a device-specific digital video signal (DVD1). The device-specific digital video signal (DVD1) is stored with the aid of a reading and writing unit (6) on a storage medium (not shown). The signal processing unit (20) has a coder (13), which converts the analogue video signal (AVin) into an MPEG II transport stream (TS1). A converter (14) converts the MPEG II transport stream (TS1) into the device-specific video signal (DVD1) suitable for recording.

The DVD recorder (1) has a further signal processing unit (21), which converts a device-specific digital video signal (DVD2), which is read from a storage medium (not shown) by the reading and writing unit (6), into an analogue video signal (AVout). The analogue video signal (AVout) is output via an analogue output (3) of the DVD recorder (1) and fed to an analogue video device or, as in the exemplary embodiment, displayed on an analogue display device (9), for example on a television. The signal processing unit (21) has a converter (7), which converts the device-specific digital video signal (DVD2) into an MPEG II transport stream (TS2). A decoder (8) converts the MPEG II transport stream (TS2) into the analogue video signal (AVout).

According to the invention, the signal processing unit (20) has an additional converter (10), which converts the MPEG II transport stream (TS1, TS2) output by the coder (13) or by the converter (7) into a video signal (DVB1) in the DVB data format. This video signal (DVB1) is output via a digital output (5) of the DVD recorder (1) and fed into a network (30). The DVD recorder (1) thus makes it possible to condition both analogue video signals (AVin) and digital video signals (DVD2), stored on storage media (not shown), for a network (30).

According to the invention, the signal processing unit (21) has an additional converter (15), which converts a digital video signal (DVB2) in the DVB data format, which is fed to the DVD recorder (1) from a network (30) via a digital input (4), into an MPEG II transport stream (TS3). This MPEG II transport stream (TS3) is converted into an analogue video signal (Avout) by the decoder (8) and output via the analogue output (3) to the analogue display device (9), or is converted into a digital video signal (DVD1) in the device-specific data format by the converter (14) and stored by means of the reading and writing unit (6) on a storage medium (not shown). The DVD recorder (1) thus makes it possible to display the digital video signals (DVB2), made available in a network (30), on an analogue display device (9) or to store them on a storage medium (not shown).

What is claimed is:

1. Digital video device for the reproduction and/or recording of a digital video signal, in a device-specific first data format based on a transport stream, the device having a coder which converts an analogue video signal, which enters into an analogue input of the device, into the transport stream, wherein it has a converter, which converts the transport stream into a digital video signal in a second data format based on the same transport stream, and a digital output, via which the digital video signal in the second data format is output.

2. Device according to claim 1, wherein it has a further converter and a decoder, the further converter converting a digital video signal in the second data format, which signal enters into a digital input of the device, into the transport stream and the decoder converting the transport stream into an analogue video signal, which is output via an analogue output of the device.

3. Device according to claim 1, wherein it has further converters, which convert the digital video signal in the device-specific first data format for reproduction into the transport stream or convert the transport stream for recording into the digital video signal in the device-specific first data format.

4. Method for converting an analogue video signal into a digital video signal in a second data format based on a transport stream, which simultaneously forms the basis for a device-specific first data format, the method having the following steps:
conversion of the analogue video signal into the transport stream by a coder,
conversion of the transport stream into the digital video signal in the second data format by a converter.

5. Method for converting a digital video signal in a second data format based on a transport stream, the transport stream forming the basis for a device-specific first data format, into an analogue video signal, the method having the following steps:
conversion of the digital video signal into the transport stream by a converter,
conversion of the transport stream into the analogue video signal in the second data format by a decoder.

6. Device according to claim 1, wherein the transport stream is an MPEG II transport stream.

7. Device according to claim 1, wherein the second data format is a DVB data format.

8. Device according to claim 1, wherein the first data format is a DVD data format.

9. Method according to claim 4, wherein the transport stream is an MPEG II transport stream.

10. Method according to claim 4, wherein the second data format is a DVB data format.

11. Method according to claim 4, wherein the first data format is a DVD data format.
